(19) United States
(12) Patent Application Publication
(10) Pub. No.: US 2016/0070806 A1
(43) Pub. Date: Mar. 10, 2016

(54) A SYSTEM AND METHOD FOR PROVIDING ORGANIZED SEARCH RESULTS ON A NETWORK

(71) Applicant: ARVOSSA INC., Ottawa (CA)

(72) Inventors: Christopher William Kergin, Ottawa (CA); Paramjit GILL, Ottawa (CA); Chung Ming Tam, Ottawa (CA)

(21) Appl. No.: 14/890,000

(22) PCT Filed: May 9, 2014
(86) PCT No.: PCT/CA2014/050441

§ 371 Date: Nov. 9, 2015

Related U.S. Application Data
(60) Provisional application No. 61/821,848, filed on May 10, 2013.

(51) Int. Cl. G06F 17/30; G06F 3/0484

(52) U.S. Cl. CPC G06F 17/30867; G06F 3/0484

(57) ABSTRACT

The present invention provides a system and method of providing organized search results on a network of one or more users having the following steps: receiving a search query, user-centric data of a primary user, and a target from the primary user on the network; retrieving user-centric data based on the target; generating a search input based on the user-centric data; providing the search input to one of at least one search provider and at least one service provider; receiving search results by the one of at least one search provider and at least one service provider; organizing the search results based on pre determined criteria; and returning the organized search results to the primary user.

### FIELD

The present invention pertains to the field of electronic search methodology and in particular to targeted searching.

### BACKGROUND

In social networks, searching is based at least in part on the past preferences and history of the initiator of the search. These searchesare considered to be direct searches in that in some instances only the past preferences and history of the search initiator is utilized. The problem with this approach is that, in a social network context, a search cannot be carried out by one person for other members of a social network (i.e.,the target for the search query is not search initiator).Searching on behalf of other members on the social network can be thought of as a third party search. In the context of presently available solutions, third party search resultsare adversely affected asonly information relating to thesearch initiator of the search is available and taken into account by the search process. Another problem is that users who are performing searches for themselves will be provided with results that do not take into account any information relating to the past preferences and history of third parties located in the social network. Search results can therefore be tainted with poor information, and valuable search results can be diluted by poor search results.

Therefore there is a need for a search which organizes search results based on a pre-selected target. The search process can include information from the initiator of the search as well as the target or targets of the search and the providers of the search results. In some embodiments, it is contemplated that the information from a classification system can be included in the search.

This background information is provided to reveal information believed by the applicant to be of possible relevance to the present invention. No admission is necessarily intended, nor should be construed, that any of the preceding information constitutes prior art against the present invention.

### BRIEF SUMMARY

An object of the present invention is to provide a system and method for providing organized search results on a network. In accordance with an aspect of the present invention, there is provided a system for providing organized search results on a network of one or more users having: a server configured to receive a search query, user-centric data of a primary user, and a target from the primary user on the network; a search generator processing engine configured to generate a search input from the user-centric data based on the target, wherein the search input is provided to one of at least one search provider and at least one service provider; a search filtering processing engine configured to receive search results from one of at least one search provider and at least one service provider, the search filtering processing engine configured to organize the search results based on pre-determined criteria, and the search filtering processing engine configured to return the organized search results to the primary user; and an interface to a communication means configured to allow communication between at least two of the server, the processing engine, and the one or more users.

In accordance with another aspect of the present invention, there is provided a method of providing organized search results on a network of one or more users having the following steps: receiving a search query, user-centric data of a primary user, and a target from a primary user on the network; retrieving user-centric data based on the target; generating a search input based on the user-centric data; providing the search input to one of at least one search provider and at least one service provider; receiving search results by one of the at least one search provider and the at least one service provider; organizing the search results based on pre-determined criteria; and returning the organized search results to the primary user.

In accordance with yet another aspect of the present invention, there is provided a method of managing user tags on multiple systems having the following steps: receiving an acknowledgement that a primary user has selected a service from one of at least one search provider and at least one service provider on the network; retrieving tag data based on the selected service from one or more users on the network; processing the tag data; and providing the tag data to the primary user; associating the processed tag data with the selected service of the primary user if the primary user, when the primary user has accepted, accepts use of processed tag data.

In accordance with yet another aspect of the present invention, there is provided a system of managing user tags on multiple systems having: a server configured to receive an acknowledgement that a primary user has selected a service from one of at least one search provider and at least one service provider on the network, and wherein the server is further configured to retrieve tag data based on the selected service from one or more users on the network; a processing engine configured to process the tag data, and wherein the tag data is associated with the selected service of the primary user if the primary user accepts use of the tag data; and an interface to a communication means configured to allow communication between at least two of the server, the processing engine, and the one or more users.

### BRIEF DESCRIPTION OF THE FIGURES

Embodiments of the present invention will be better understood in connection with the following Figures, in which:

FIG. 1 illustrates oneembodiment of a system configuration of the improved search method in accordance with the present invention;

FIG. 2 illustrates a flowchart outlining one embodiment of the flowchart presenting the data flow for the query modifier in accordance with the present invention;

FIG. 3 illustrates a flowchart presenting one embodiment of the data flow for the result modifier in accordance with the present invention;

FIG. 4 illustrates a flowchart presenting one embodiment of the data flow for tag matching in accordance with the present invention; and

FIG. 5 illustrates a flowchart presenting one embodiment of the data flow for the feedback process in accordance with the present invention.

### DETAILED DESCRIPTION

### Definitions

The term targetcan be used to define the user(s) for whom the search on the Search Provider or Service Provider is being conducted. Target can represent any one user, set of users, class of users, or custom subset or users on a social network.

The term user-centric datacan be used to refer to all data that pertains to the user and may include, but is not limited to, personal informationof the user (e.g., age, sex, profession, education, address), demographic information of a user, a user's history on a social network, time and location specific events,a user's interactions with other members of the social network,a user's interactions with one or more Service Providers and Search Providers, purchase history, search history, a user's interactions with the Optimizer, tag data, among other types of data readily understood by the skilled person.User-centric data can be provided by the user (e.g., mailing address, age, gender), assigned to the user by a third party (e.g., survey administered by a third party to assess characteristics or qualities of the user), inferred from time and location specific events (e.g., trips to the opera may imply interest in classical music, upscale tastes, or conservative personality), or collected from external sources such as other social networks or databases storing user-centric data.

The term tag is used to define descriptor data that can be assigned to a user, product or service, among other arrangements that will be readily understood by the skilled person.ln at least one embodiment, tags may be expressly generated by the user, Service Provider, or Search Provider in association with any entity, item, topic, subject, platform, social network, application, message board, forum, and software. In at least one embodiment, tags may generated by the Optimizer implicitly, known as implicit tags which the Optimizer creates based on association of the user with the associated entity, item, topic, subject, platform, social network, application, message board, forum, and software. Tags can be stored on one or more social networks or third party sites, on the Service Provider, on the Search Provider, on the Optimizer, or any database system that the Optimizer can access.

The term knowledge base refers to information that the Optimizer may possess and the logic to act on that information in order to provide the services of query modification, results modification, implicit tag generation, and tag processing. The Optimizer can collect information to fill the knowledge base from external sources (such as data repositories, social networks, consumer reports, independent studies, and other similar information sources understood by a skilled person in the art) and, if the Optimizer is independent, the organization that is maintaining the Optimizer (such as the organization's subject matter expertise, classification system) may provide the information for the knowledge base.

The term Service Provider is used to define any entity providing goods and services that can be assigned to a user, product or service, among other arrangements that will be readily understood by the skilled person. Service providers may include online retailers, online marketplaces, online ecommerce constructs, and conventional retailers, wholesalers, shops, and marketplaces.

The term Search Provider is used to define any entity which provides information based on search data and/or queries that can be assigned to a user, product or service, among other arrangements that will be readily understood by the skilled person. Search providers may include commercial services such as Google and Microsoft Bing, among other commercial search engines. Search providers may also include searchable social networks such as Facebook, Google+, Twitter, Pinterest, Instagram, Tumblr, among other social networks readily understood by the skilled person.

Unless defined otherwise, all technical and scientific terms used herein have the same meaning as commonly understood by one of ordinary skill in the art to which this invention belongs.

### System Overview

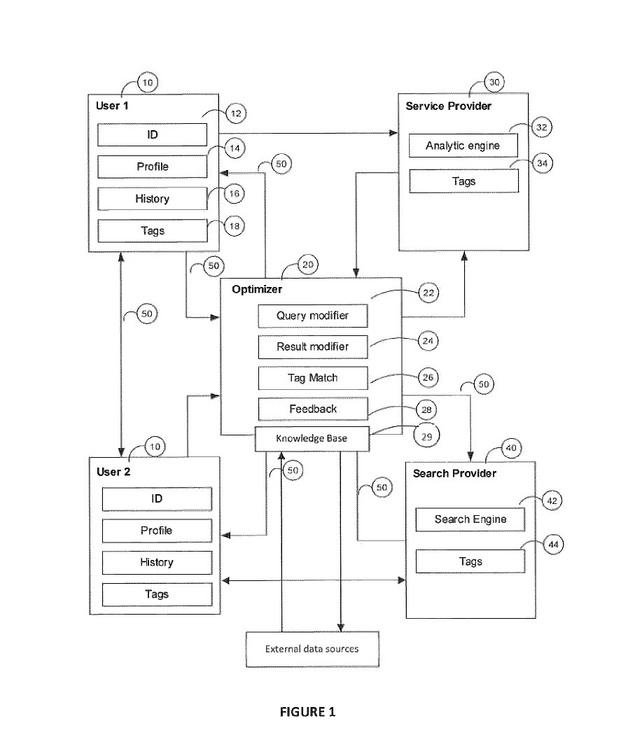

The present invention provides a system and method to provide improved search results on social networks. The components and their interactions for the system and method are summarized in FIG. 1. In FIG. 1, the main participants for the system are a User (10), an Optimizer (20), a Service Provider (30), a Search Provider (40) and communication channels (50) between different participants. User (10) by definition exists on a social network. Optimizer (20) is a specific computing service that provides improved search results and enables improved data quality of the system. Service Provider (30) provides a service to User (10). Both online and offline retailers are examples of Service Provider (40). Search Provider (40) provides a network search service to User (10).

FIG. 1 is a logical decomposition of the system and method, which will be readily understood by the skilled person for translation into a physical implementation to those skilled in the art. The Optimizer module may be implemented in any number of component configurations, as will be readily understood by the skilled person. In at least one embodiment, a single hardware component, such as server hardware, is implemented to perform the functionality of the Optimizer module. In at least one embodiment, multiple components such as a server, processing engine, and knowledge base, are implemented to perform the functionality of the Optimizer module. Each of the components may be of any implementation which allows for reception of data from the plurality of users from a communication interface and storage and manipulation functions. These implementations may include local resources, cloud based resources, or any hybrid resource configuration. In at least some embodiments, the segregated modules may be part of the same piece of discrete hardware with segregated functions; while in other embodiments, the segregated modules may include one or more pieces of discrete hardware.

In the embodiment where the Optimizer module contains the singular module, namely a server, the server can perform a number of functions. For example, the server is configured to receive the search query from the one or more users, generating a search input based on the user centric data, providing the Search Provider/Service Provider, receiving the search results and finally organizing and returning the results to the one or more users.

In the embodiment where the Optimizer module contains multiple modules, the following implementation is enacted. A server is utilized to receive the search query from the one or more users. The server passes the request to the processing engine which generates a search input and provides the input to a Search Provider/Service Provider. The processing engine then receives the search results and organizes and returns the search results to the one or more users. A database (e.g., knowledge base) may be implemented which serves to store search specific data for each user.

A communication means is contemplated which allows for data packet transfer between each of the hardware modules. The communications means would be understood by a person skilled in the art to include any necessary elements of hardware, including but not limited to communications ports, wireless transmitter/receivers, wires or fiber optics; and software, including but not limited to telephony, e-mail, facsimile, Bluetooth®, TCP/IP, FTP, XML, and IRC, that allow a network enabled device to exchange data packets with another network enabled device.

Moreover, the presently claimed invention may be captured by integrated software and hardware wherein the hardware implementation may be of the implementation discussed previously while the software implementation may be any means known in the art including local installation of a software application on a mobile device with minimal retrieval of extraneous data from server. In at least one embodiment, the software application is a “thin client” on the subscriber device and retrieves substantial amounts of information from the server with the minimum amount of local storage required for functionality. In at least one embodiment, the software application is accessed through a network client (e.g., web browser, third party aggregator application). In at least one embodiment, the implementation of the application may include a hybrid of conventional paradigms such as those described above.

In at least one embodiment, the entire system and method can reside in and be implemented by the owner of the Social Network, Service Provider (30) or Search Provider (40), or can reside independently; however, the logic components will still exist in its implementation.

In FIG. 1, only two Users (10) are represented. It is understood to those skilled in the art that there maybe more than one User (10) on a social network. User (10) on a social network contains four components: aUser ID (12), a User Profile (14), a User History (16), and User Tags (18). User ID (12) represents a unique identifier for the User. Examples of User ID (12) are an e-mail address, a real name or a social network nickname. User Profile (14) represents user-centric data about User (10). User History (16) represents a record of User activity on the social network. This information includes time and location specific events as well as their interactions with other members of the social network as well as their interactions with one or more service and search providers. Purchase history and search history, for example, are examples of activities recorded by the system. User Tags (18) are user applied terms for online content such as an item being tagged by a user as on their “wishlist” or a movie as being scary.

Service Providers (30) provide a service to the User (10). Retailers are examples of a Service Provider (30) since they provide goods to a user. A Service Provider (30) can have at least one of the following components: aService Provider Analytical Engine (32) and a Service Provider Tag Service (34). Service Provider Analytical Engine (32) answers the query from the User. Examples of query can be an inventory search or a recommendation engine. Service Provider Tag Service (34) provides word classification systems for the Service Provider's goods and services. Examples of tags are labeling music as “classical” or clothing as “dramatic.”

Search Provider (40) provides a search service for the User. Search Provider (40) can have at least one of the following components: a Search Provider Search Engine (42) and a Search Provider Tag Service (44). Search Provider Search Engine (42) answers a key word or key phrase search from the User based on the information available to Search Provider Search Engine (42). Search Provider Tag Service (44) provides word classification systems for the information available to the Search Engine (42). Typically, for a Search Provider (40), Search Provider Tag Service (44) can be organized into a hierarchical directory classification system.

The Optimizer (20) is a computer system programmed to improve the search and response to the User (10) for both the Service Provider (30) and the Search Provider (40). The Optimizer can be composed of at least one of the following components: anOptimizer Query modifier (22), anOptimizer Result Modifier (24), anOptimizer Tag Match Service (26), anOptimizer Feedback Service (28), and a Knowledge Base (29).Optimizer Query Modifier (22) modifies a User's query based on relevant information on one or moresocial networks for which the User has assigned data. The relevant information is based on the object of the search. Optimizer Result Modifier (24) is a service that collates and modifies the results returned by either the Service Provider (30) or the Search Provider (40).The modification is based on information that is available on the User's social network. The Tag Match (26) compares the tags of the User and the social network to those of the Service Provider (30) or the Search Provider (40)and returns the appropriate content back to the User. Optimizer Feedback Service (28)allows a User to elicit comments from other Users on the Social Network on the goods or servicesprovided by the Service Provider (30) or the Search Provider (40). The Knowledge Base (29) is information about the goods and services that are provided by the Service Provider (30) or the Search Provider (40)and information about the users that may assist in providing the appropriate goods and services to the correct users. The Knowledge Base (29) is particularly important if the Optimizer (20) is independent of the one or more social network systems, the Search Provider, and the Service Provider. The Knowledge Base (29) can collect information from external sources and from the developer of the Optimizer (20). In at least one embodiment, the developer of the Optimizer (20) is an administrator of the Optimizer (20)or system as a whole. In at least one embodiment, the developer of the Optimizer (20) is a third party entity.

The modification of the search on the system depends on the configuration of the Service Provider (30) or the Search Provider (40). The initial query from the User can be modified by the Optimizer (20) through the Optimizer Query Modifier (22) or the returned search results can be aggregated and combined by the Optimizer (20) using the Optimizer Result Modifier (24).

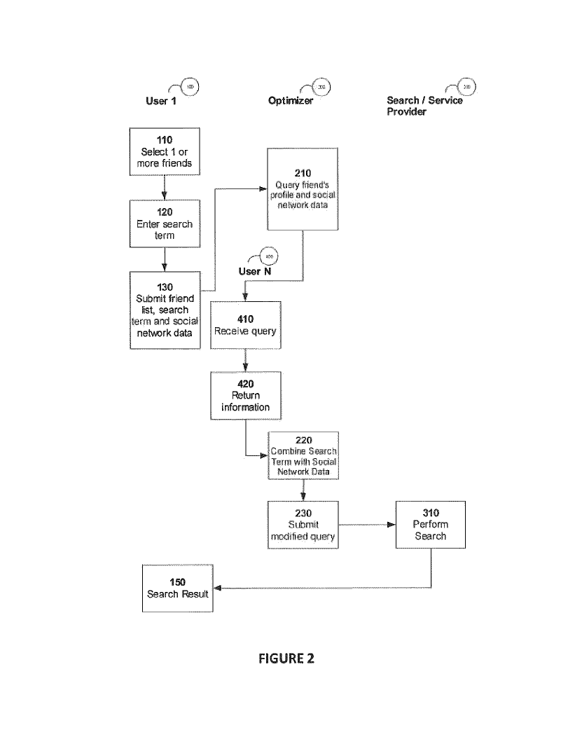

FIG. 2 is the data flow for the Optimizer's query modifier. This component improves search service by incorporating available social network data through a search modifier. The data flow involves the interactions and communications between four participants: User 1 (100) on a social network, the Optimizer (200), the Search or Service Provider (300) and at least one other User on a Social Network as represented by User N (400). The system and method starts with User 1 (100) on a Social Network selecting one or more users (110) as targets and entering a search term (120),then submitting the list of targets, the search term, and the User's social network data relevant to the search term to the Optimizer (130). In some embodiments, the Optimizer is configured to automatically retrieve data from one or more social networks relevant to the search term using automatic fetch processes. The user may allow or disallow this feature by controlling their respective permission controls to the system. In other embodiments, the Optimizer is sent social network data from the user, where the user selects specific data to be forwarded to the Optimizer. The Optimizer then uses the list of targets and performs a query on each of the targets' profiles and for the relevant social network data related to the search term (210). The social network receives the query for information for User N (410) and returns the requested information back to the Optimizer (420). The Optimizer then combines the Search Term with the relevant Social Network data from User (100) and User (N) to form a modified query (220). The Search Term is modified with pre-determinedlogic with respect to the Optimizer to refine the search query taking into account the combination of all relevant information. For example, if the search term is “pants” and the target is “Steve”, then the Optimizer will know to take the available social network information regarding Steve's waist and inseam measurement (e.g., 32 in×32 in). It will then submit “pants 32 in×32 in” to the Search or Service Provider. This modified query is submitted to the Search Provider or Service Provider (230). The Search Provider or Service Provider (300) performs the search with the modified search information (310) and returns the result back to User (150).

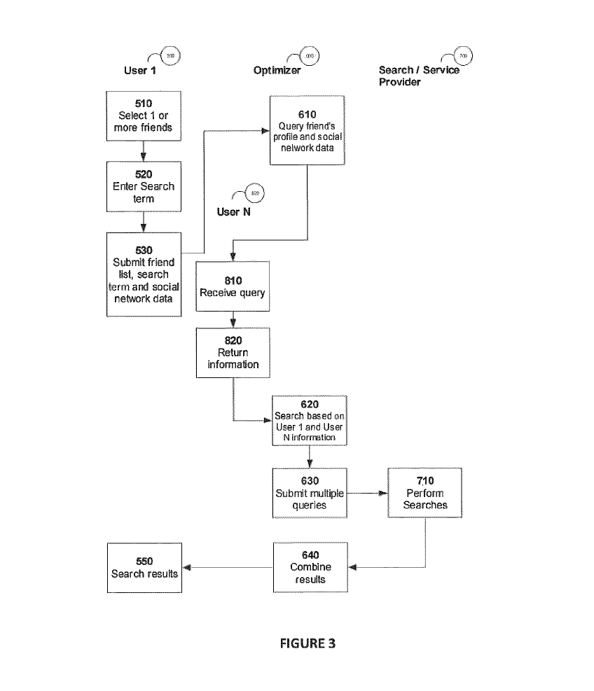

FIG. 3 is the data flow for the Optimizer's result modifier. This component improves search service by incorporating available data from one or more social networksfor which the user has data assignedthrough multiple searches. The data flow involves the interactions and communications between four participants: User 1 (500) on a social network, the Optimizer (600), the Search or Service Provider (700) and at least one other User on a Social Network as represented by User N (800). The system and method starts with User 1 (500) on a Social Network selecting one or more Users (510) as the target for the search, enters a search term (520) and submits the list of targets, the search term and the User's social network data relevant to the search term to the Optimizer (530). The Optimizer then uses the list of targets and performs a query on each of the targets' profiles for the relevant social network data related to the search term (610). The social network receives the query for information for each User N (810) and returns the requested information back to the Optimizer (820). The Optimizer creates multiple searches each based on the initial Search Term and the relevant Social Network data from User (500) and each User (N) (620). The Optimizer then submits multiple queries to the Search or Service Provider (630). The Search Provider or Service Provider (700) performs each search (710) and returns the result back to Optimizer. The Optimizer then can combine the search results based on one or more criteria (640). The search results can then be modified with pre-determined logic with respect to the Optimizer to refine the results of the search query by taking into account the combined information of all the users, the Search Providers, and the Service Providers. Weighted analysis can be conducted on consensus search results from all Search Providers and Service Providers.For example, a primary user submits a query for a list of friends (e.g., “food” for “Steve and Ethel”). The Optimizer will submit two independent queries to the Search/Service Provider (“food+[Steve data]” and “food+[Ethel data]”) in the same manner as stated above. Once the two result sets are returned (e.g., {lasagne, pizza} for Steve and {lasagne, chicken} for Ethel), the Optimizer will compare the two sets and combine them using programmed logic (in this case, “lasagne” is the only common result to both results sets so the Optimizer will return “lasagne” to the primary user). The logic is dependent on the subject matter and may vary. In some cases, the final results set will be exclusive (“lasagne” was the only common result so it is the only item returned) and in others it will be weighted ({lasagne, pizza, chicken} are all returned with higher weight given to “lasagne” since it appeared twice), and in other configurations the Optimizer will return the exhaustive set ({lasagne, pizza, chicken} with no weighting). Examples of criteria include elimination of duplicates or weighted or ranking methods for the order of result presentation. The Optimizer then delivers this combine result back the User (550).

The Optimizer may be thought of as comprising an information gathering function,a search generator function, and a search filtering function. The information gathering function handles the querying (810) for each of the targets' profiles and relevant social network data related to the search term (610). Once this information is retrieved (820), the search generator function generates a search input (620) based on the primary user's user-centric data (if required for target), the target's user-centric data (if different than primary user), the search query, and the target. The search generator also submits queries to the Search Provider or Service Provider (630). A search filtering function is the final sub-set of sub-functions of the Optimizer where the search filtering function combines and organizes the results based on pre-determined criteria (640).

In some embodiments, the modification of the input into the Search Provider and Service Provider is accomplished by modifying the search variables externally after receiving information from the user (search term, search target, and user's user-centric information), where the modified search input is created independent of the Search Provider or Service Provider. The modified search input is then provided to the Search Provider or Service Provider for the modified search. For example, a search for “bread” turns into a search for “gluten-free bread” once the target's food restrictions are identified through the optimizer's data gathering on the social network.

In other embodiments, the current system/method integrates directly with the Search Provider or Service Provider through the native Search Provider or Service Provider's Application Programming Interface. In this configuration, the modification to the search input is conducted at the application layer level utilizing the features and definitions enabled through the respective Search Provider or Service Provider's Application Programming Interface.

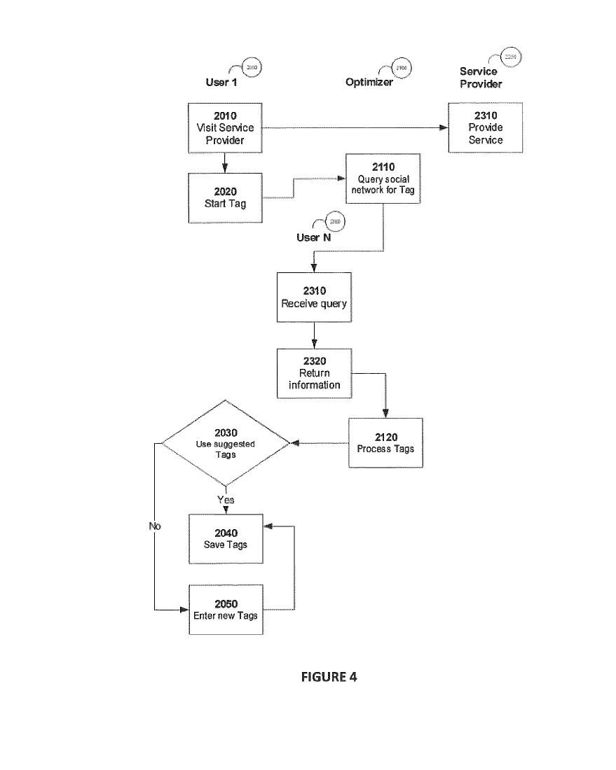

FIG. 4 is the data flow for the Optimizer's Tag Match process. This component allows the user to label services based on a common language defined by the User's social Network. The data flow involves the interactions and communications between four participants: User 1 (2000) on a social network, the Optimizer (2100), the Service Provider (2200) and at least one other User on a Social Network as represented by User N (2300). The system and method starts with User 1 (2000) visiting the Service Provider (2010). Accordingly, the Service Provider (2200) provides a service (2310). At the same time, Tagging service (2020) is initiated. The Tagging service can be initiated by either the User or the Optimizer. As a result, the Optimizer (2100) queries the social network for Tag (2110) on the service. This query is sent to User N (2300). User N receives the query (2310) and returns the relevant information (2320). The Optimizer processes the Tags (2120). Examples of processing include the elimination of duplication or a ranking of relevance for the Tags. At this point, the Processed Tags can be sent back to User 1 (2000) or used by the Optimizer to modify the query to the Search Provider or Service Provider. If sent back to the user, User 1 (2000) then has the choice of using the Tags (2030). If he uses the Tags from the social network, the Tags are saved and associated with the service (2040). If the answer decision is not to use the social network tags, then User 1(2000) can enter new Tags (2050).

The Optimizer module may be considered to comprise a processing functionwhich retrieves relevant information (2320) from User N (2300). The processing function then processes the Tags (2120). The decision process regarding User 1's process flow described above is also handled by the processing function.

In at least one embodiment, the Optimizer is configured to generate implicit tags for a user, Service Provider, or Search Provider associated with an entity, item, topic, subject, platform, social network, application, message board, forum, and software. These implicit tags are taken into consideration during the processing function based on tags, despite the lack of express creation of the tag by the user. Searches with a pre-determined target selection by a user would utilize the implicit tags of the target as additional data parameters in order to provide a more targeted search with respect to the target.

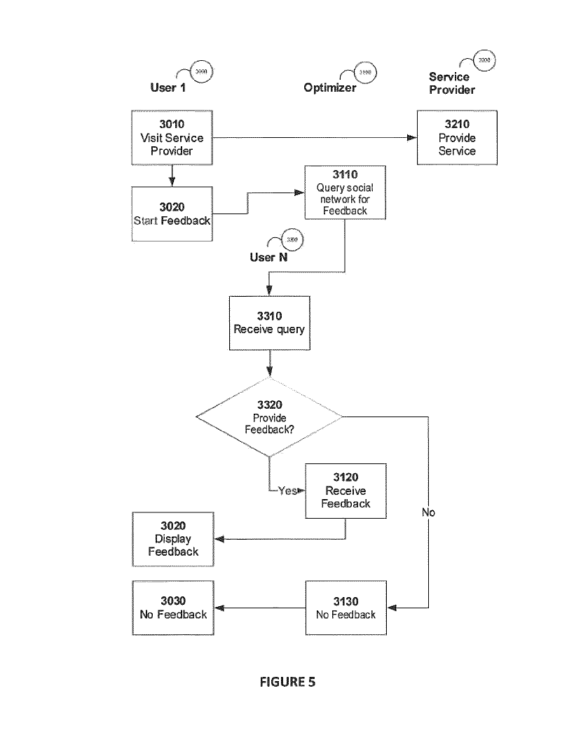

FIG. 5 is the data flow for the Optimizer's Feedback process. This component allows the user to solicit advice from the User's one or more social networks for which the user has assigned data. The data flow involves the interactions and communications between four participants: User 1 (3000) on a social network, the Optimizer (3100), the Service Provider (3200) and at least one other User on a Social Network as represented by User N (3300). The system and method starts with User 1 (3000) visiting the Service Provider (3010). Accordingly, the Service Provider (3200) provides a service (3210). At the same time, User 1 (3000) starts the Feedback service (3020). As a result, the Optimizer (3100) queries the social network for Feedback (3110) on the service. This query is sent to User N (3300). User N receives the query (3310) and is given a choice of providing Feedback or refusing to provide a comment (3320). If User N provides Feedback on the service, the Feedback is received by the Optimizer (3120) and sent back to User 1(3020),If the User N does not provide feedback, the Optimizer registers this action (3130) which is pushed to the User (3030). The Optimizer can weigh the feedback based on relevant user-centric information of the users providing feedback on the social network. For example, if Allison is shopping for a shirt for her friend Betty, she can solicit the opinions of users on her social network. Those opinions may be weighted more heavily if they come from Betty's husband, Carter, or from a fashion designer, Denise.

The invention will now be described with reference to specific examples. It will be understood that the following examples are intended to describe embodiments of the invention and are not intended to limit the invention in any way.

### EXAMPLES

### Example 1

### Answering a Question for a Friend

User 1 wants to answer a question for a friend (User 2). User 1 selects the friend (User 2) as the target of the search. User 1 types a query in a search engine, the search engine returns the results then filters the result based on the information and preference of User 2.

### Example 2

### Shopping for Yourself

User 1 wants to shop for herself at a retail product provider and thus selects herselfas the target of the search. The search engine from the retail product provider returns the results filtered and ordered based on the information and preference of User 1.

### Example 3

### Shopping for a Friend

User 1 wants to shop for a friend (User 2). User 1 selects the friend (User 2) as the target of the search. User 1 types a query in a retail product provider, the search engine from the retail product provider returns the results then filters and orders the result based on the information and preference of User 2.

### Example 4

### Shopping for a Target In-Store

A User goes to a brick and mortar store to shop for a target—either themselves or someone in their network. The User selects the target and then using wireless communication such as NFC, the User can provide the information and preferences of the target to the retailer who then returns a result set filtered and ordered based on the information and preferences provided.

### Example 5

### Shopping for a Group of People

A User wants to shop for a group of people. The User selects all the targets to be included in the search. The User then types a query in a product provider, the search engine from the product provider returns the results filtered and ordered based on the information and preferences of the targets selected by the User.

### Example 6

### Shopping for a Group of People

A user (User 1) wants to shop for a group of people where each target is returned an individual result (e.g., a baseball team coach needs uniforms for his players). User 1 (coach) selects the targets (players) and enters a query in a product provider (jersey store). The product provider then returns a result set with a single item for each individual target (e.g., a jersey for each player).

EXAMPLE 7: Shopping for a Service for a Friend

A user (User 1) wants to hire a service (e.g., florist) for another user in their social network. User 1 selects the target and initiates the search for the service. The query modifier then uses information about the target (e.g., likes lilies) to modify the search for the service (e.g., florist that sells lilies) and returns the result to User 1.

### Example 8

### Searching for Information for a Friend

A user (User 1) wishes to search for information on behalf of a friend (User 2) (e.g., a concert that User 2 will enjoy). User 1 selects the target (User 2) and then enters the search terms into a Search Provider (e.g., “concert” into Google search). The query modifier modifies the query to include information about the target (e.g., enjoys classical music) and submits the modified query to the Search provider. The optimizer then returns the results set to User 1.

EXAMPLE 9: Shopping for a Friend (Results Modifier)

A user (User 1) wishes to shop for a friend (User 2). User 1 selects User 2 as the target and then submits a query to the Optimizer (e.g., music). The Optimizer then submits the query to the Service Provider which returns a result set to the Optimizer (e.g., list of music CDs available for purchase). The Optimizer then reorders the result set based on user-centric information about User 2 (e.g., prioritizes hip hop music over classical music) retrieved from Facebook and Twitter data of User 2.

### Example 10

### Shopping for a Group of People (Results Weighting)

A user (User 1) wants to shop for group of people in a situation where User 1 only needs to purchase one item for the group (e.g., dinner meal). User 1 selects the targets and submits the query to the Service Provider. The Service Provider then returns a result set for each individual selected. The optimizer then combines information from the Service Provider and the users to organize the result set. For example, if “lasagne” and “salmon” were returned for all users, then “lasagne” may be prioritized over “salmon” because “salmon” is out of season (information from the Service Provider) and the users are all Italian (information about the users).

### Example 11

### Example of Tag Match

A user (User 1) is looking to make a purchase (e.g., favorite book) for another user (User 2) on his network. User 1 selects User 2 as the target and submits the query (favorite book) to the Service Provider. The Optimizer queries User 2 for the relevant data (list of favorite books) and submits the information to the Service Provider. The Service Provider then returns the result set (e.g., Huckleberry Finn for $39.99) to User 1.

### Example 12

### Over-riding a Tag

User 1 is looking to purchase a movie so they submit a query for a movie into a Service Provider. When the Service Provider returns a result, the Optimizer queries the social network for information regarding that result. User 2, a member of User l′s social network, has provided a tag for that search result (e.g., “terrible”) and the Optimizer returns that tag to User 1. User 1 then has the chance to save that tag as their own (labeling the movie “terrible” as well) or to provide another tag (e.g., “excellent”) to the search result.

### Example 13

### Requesting Feedback with Weighted Results

User 1 is looking to buy themselves a product (e.g., sweater). After finding a product with a Service Provider, User 1 selects targets from which to request feedback and initiates the Optimizer's feedback system. The Optimizer collects the feedback from the targets and prioritizes them based on user-centric information about the user that provided it (e.g., it may weigh one feedback more strongly since the provider is a fashion designer or because there is a high correlation between purchase rate and positive feedback from a specific user).

### Example 14

### An independent Optimizer Leveraging its Knowledge Base

User 1 wishes to buy a sweater for User 2. User 1 submits a query to the Optimizer that sends the query to the Service Provider while at the same time sending a query to User 2 on a social network for relevant information. The Service Provider then returns a set of results (e.g., different sweaters) to the Optimizer. Based on the Optimizer's knowledge of User 2 and its own Knowledge Base on sweaters, it can filter the results provided from the Service Provider and then returns the filtered set to User 1 (e.g., if User 2 has a conservative style personality, the Optimizer can identify which sweaters in the result set fit that description and then only return the relevant ones to User 1).

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A system for providing organized search results on a network of one or more users comprising:
a server configured to receive a search query, user-centric data of a primary user, and a target from the primary user on the network,the primary user selected from the one or more users on the network;
a search generator processing engine configured to generate a search input from the user-centric data based on the target, wherein the search input is provided to one of at least one search provider and at least one service provider;
a search filtering processing engine configured to receive search results from one of the at least one search provider and the at least one service provider, the search filtering processing engine configured to organize the search results based on pre-determined criteria, and the search filtering processing engine configured to return the organized search results to the primary user; and
an interface to a communication means configured to allow communication between at least two of the server, the processing engine, and the one or more users.

2. A system of claim 1, wherein the user-centric data is selected from the group consisting of: a user's personal information, information that may have been assigned by a third party, inferred information from behavior on the social network or from time and location specific events, collected information from external sources,collected information from other social networks,collected information from databases storing user-centric data, history on a social network, time and location specific events, interactions with other members of the social network, interactions with one or more service and search providers, purchase history, search history, and tag data.

3. A system of claim 1, wherein the search target is selected from the one or more users on the network.

4. A system of claim 1, wherein the at least one search provider may be a search engine.

5. A system of claim 1, wherein the at least one service provider may be an online or offline retailer.

6. A system of claim 1, wherein the operations of at least one of the search generator processing engine and the search filtering processing engine are conducted by respective application programming interfaces of the at least one of at least one search provider and at the least one service provider.

7. A method of providing organized search results on a network of one or more users comprising the following steps:
receiving a search query, user-centric data of a primary user, and a target from the primary user on the network;
retrieving user-centric data based on the target;
generating a search input based on the user-centric data;
providing the search input to one of at least one search provider and at least one service provider;
receiving search results from the one of at least one search provider and at least one service provider;
organizing the search results based on pre-determined criteria; and
returning the organized search results to the primary user.

8. A method of claim 7, wherein the user-centric data is selected from the group consisting of:
a user's personal information, information that may have been assigned by a third party, inferred information from behavior on the social network or from time and location specific events, collected information from external sources, collected information from other social networks, collected information from databases storing user-centric data, history on a social network, time and location specific events, interactions with other members of the social network, interactions with one or more service and search providers, purchase history, search history, and tag data.

9. A method of claim 7, wherein the target is one or more users on the network.

10. A method of claim 7, wherein the at least one search provider may be a search engine.

11. A method of claim 7, wherein the at least one service provider may be an online or offline retailer.

12. A method of managing user tags on multiple systems comprising the following steps:
receiving an acknowledgement that a primary user has selected a service from one of at least one search provider and at least one service provider on the network;
retrieving tag data based on the selected service from one or more users on the network;
processing the tag data; and
associating the tag data with the selected service of the primary user if the primary user, accepts use of the tag data.

13. A method of claim 12 wherein, retrieving the tag data based on the selected service from one or more users on the network is based on the primary's user's specified target.

14. A method of claim 13, wherein the target is one or more users on the network.

15. A method of claim 12 wherein, processing of the tag data comprises elimination of duplication of tags and ranking of relevance for tags.

16. A system of managing user tags on multiple systems comprising:
a server configured to receive an acknowledgement that a primary user has selected a service from one of at least one search provider and at least one service provider on the network, and wherein the server is further configured to retrieve tag data based on the selected service from one or more users on the network;
a processing engine configured to process the tag data, and wherein the tag data is associated with the selected service of the primary user if the primary user accepts use of the tag data; and
an interface to a communication means configured to allow communication between the server, the processing engine, and the one or more users.

17. A system of claim 16 wherein, retrieving tag data based on the selected service from one or more users on the network is based on the primary's user's specified target.

18. A system of claim 17 wherein, wherein the target is one or more users on the network.

19. A system of claim 17 wherein, processing of the tag data comprises elimination of duplication of tags and ranking of relevance for tags.
